(19) United States
(12) Patent Application Publication
(10) Pub. No.: US 2007/0228958 A1
(43) Pub. Date: Oct. 4, 2007

(54) PLASMA DISPLAY PANEL AND MANUFACTURING METHOD THEREOF

(75) Inventors: Kyung Wha LEE, Seoul (KR); Jae Sang CHUNG, Seongnam-si (KR)

Correspondence Address: FISH & RICHARDSON P.C., P.O. BOX 1022, MINNEAPOLIS, MN, 55440-1022, US

(73) Assignee: LG ELECTRONICS INC., Seoul (KR)

(21) Appl. No.: 11/692,319

(22) Filed: Mar. 28, 2007

(30) Foreign Application Priority Data
Mar. 28, 2006 (KR) 10-2006-0027857

(51) Int. Cl. H01J 17/49; H01J 9/24; H01J 9/38

(52) U.S. Cl. 313/582; 445/24; 445/38; 313/586

(57) ABSTRACT

A plasma display panel and a manufacturing method thereof are disclosed. The plasma display panel includes discharge cells which are partitioned by an upper panel, a lower panel, and barrier ribs, and at least one groove which is formed on the upper panel correspondingly to the discharge cells.

This application claims the benefit of Korean Patent Application No. 10-2006-0027857, filed on Mar. 28, 2006, which is hereby incorporated by reference as if fully set forth herein.

### BACKGROUND OF THE INVENTION

1. Field of the Invention

The present invention relates to a plasma display panel, and more particularly, to an exhaust port that is formed on an upper panel of a plasma display panel.

2. Discussion of the Related Art

A plasma display panel has a structure in which barrier ribs provided between an upper panel and a lower panel form discharge cells. An inert gas containing a primary discharge gas, such as neon, helium, or a mixed gas thereof, and a small amount of xenon is charged in respective discharge cells. When the discharge happens with a high-frequency voltage, vacuum ultraviolet rays are generated by the inert gas and causes fluorescent substances between the barrier ribs to emit light so that an image is formed. Such a plasma display panel is highlighted as a next generation display device because the plasma display panel has an advantage of a thin and light constitution.

FIG. 1 is a perspective view illustrating schematically the structure of a plasma display panel. As shown in FIG. 1, an upper panel 10 of the plasma display panel is provided with a plurality of sustain electrode pairs made up of scan electrodes 2 and sustain electrodes 3 that are arranged in pairs on a top glass substrate 1 which is an image display surface. And, a lower panel 20 is provided with a plurality of address electrodes 13 that are arranged on a bottom glass substrate 11 such that the address electrodes 13 cross the sustain electrode pairs. The upper panel 10 and the lower panel 20 are sealed parallel at a distance from each other.

Barrier ribs 12 of a stripe type (or a well type) for forming a plurality of discharge spaces, i.e., discharge cells, are arranged in parallel with each other on the lower panel 20. A plurality of address electrodes 13 for generating vacuum ultraviolet rays through an address discharge are disposed in parallel with the barrier ribs 12. Red (R), green (G) and blue (B) fluorescent substances 14 which emit visible light for the image display at the address discharge are coated on the top surface of the lower panel 20. And, a lower dielectric substance layer 15 is formed between the address electrodes 13 and the fluorescent substances 14 to protect the address electrodes 13.

Due to shock by positive ions at the point of discharge, an upper dielectric substance 4 provided at the upper panel 10 may be worn out, and a metal material like sodium (Na) may cause a short of the electrodes. To solve this problem, the upper dielectric substance 4 is coated with a protective film 5 of magnesium oxide (MgO) so as to protect the upper dielectric substance 4. This is because magnesium oxide (MgO) endures the shock by the positive ions, has a high coefficient of secondary electron emission, and decreases a firing voltage.

In the process of manufacturing the plasma display panel, an exhaust port is formed at the upper panel or the lower panel to exhaust impurities such as hydrogen (H₂) and carbon dioxide (CO₂) existing inside the discharge cells. Then, the discharge cells are made almost vacuous, and the inert gas containing helium is injected into the discharge cells.

FIG. 2 is a view illustrating schematically an exhaust port of the conventional plasma display panel. As shown in FIG. 2, the upper panel 10 and the lower panel 20 are sealed to form the plasma display panel, and impurities existing in a discharge region 150 is exhausted outside through an exhaust port 170. However, the exhaust process is not achieved smoothly.

If the inert gas is charged into the discharge cells in the state that the impurities are not removed sufficiently, the impurities may adhere to the barrier ribs or the protective film and cause a change of properties of the elements. And, it may affect adversely discharge characteristics or brightness in the operation of the plasma display panel.

### SUMMARY OF THE INVENTION

Accordingly, the present invention is directed to a plasma display panel that substantially obviates one or more problems due to limitations and disadvantages of the related art.

An object of the present invention is to provide a plasma display panel and a manufacturing method thereof that is capable of exhausting impurity gases existing inside discharge cells when sealing an upper panel and a lower panel of the plasma display panel.

Another object of the present invention is to provide a plasma display panel and a manufacturing method thereof that is capable of maintaining properties of barrier ribs or a protective film and increasing discharge characteristics and brightness in the operation.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve the object and other advantages and in accordance with the purpose of the invention, as embodied and broadly described herein, a plasma display panel comprises: discharge cells which are partitioned by an upper panel, a lower panel, and barrier ribs; and at least one groove which is formed on the upper panel correspondingly to the discharge cells.

In another aspect of the present invention, a method for manufacturing a plasma display panel comprises: forming at least one groove on an upper panel; sealing the upper panel with a lower panel formed with barrier ribs; and exhausting a gas inside discharge cells partitioned by the upper panel, the barrier ribs and the lower panel through the groove.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a perspective view illustrating schematically a structure of a conventional plasma display panel;

FIG. 2 is a view illustrating schematically an exhaust port of the conventional plasma display panel;

FIG. 3 is a view illustrating schematically a top substrate formed with grooves of a plasma display panel in accordance with a first embodiment of the present invention;

FIG. 4 is a view illustrating mimetically a structure of discharge cells of the plasma display panel formed with the grooves in accordance with the first embodiment of the present invention;

FIG. 5a is a perspective view illustrating schematically a top substrate formed with grooves of a plasma display panel in accordance with a second embodiment of the present invention;

FIG. 5b is a sectional view seen from the B-side in FIG. 5a;

FIG. 5c is a sectional view seen from the A-side in FIG. 5a;

FIG. 6 is a sectional view illustrating schematically the plasma display panel formed with the grooves in accordance with the second embodiment of the present invention; and

FIG. 7 is a flow chart illustrating a manufacturing method of the plasma display panel formed with the grooves in accordance with the present invention.

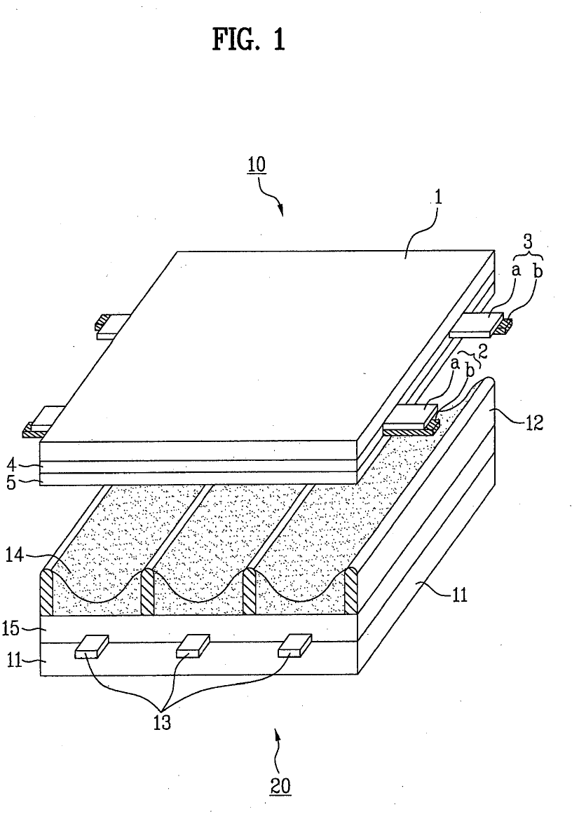

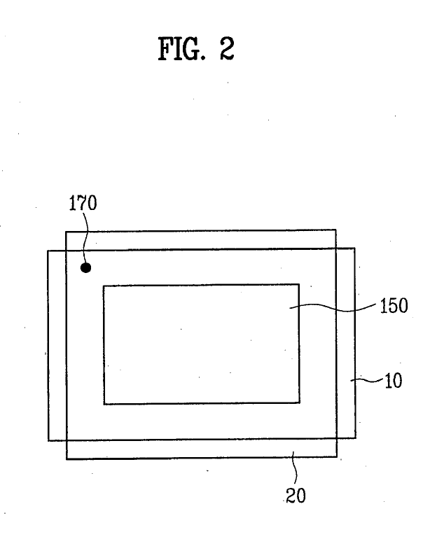

### DETAILED DESCRIPTION OF THE INVENTION

Reference will now be made in detail to the preferred embodiments of the present invention associated with a plasma display panel and a manufacturing method thereof, examples of which are illustrated in the accompanying drawings. Wherever possible, the same reference numbers will be used throughout the drawings to refer to the same or like parts.

A plasma display panel according to the present invention has a structure in which an upper panel is formed with grooves for exhausting impurities such as hydrogen (H₂) and carbon dioxide (CO₂) existing inside discharge spaces. The grooves are formed on a glass substrate of the upper panel or an upper dielectric substance, preferably formed on the surface opposing the discharge spaces. Therefore, the impurities existing inside the discharge spaces pass along the grooves and are exhausted outside of the plasma display panel through an exhaust port.

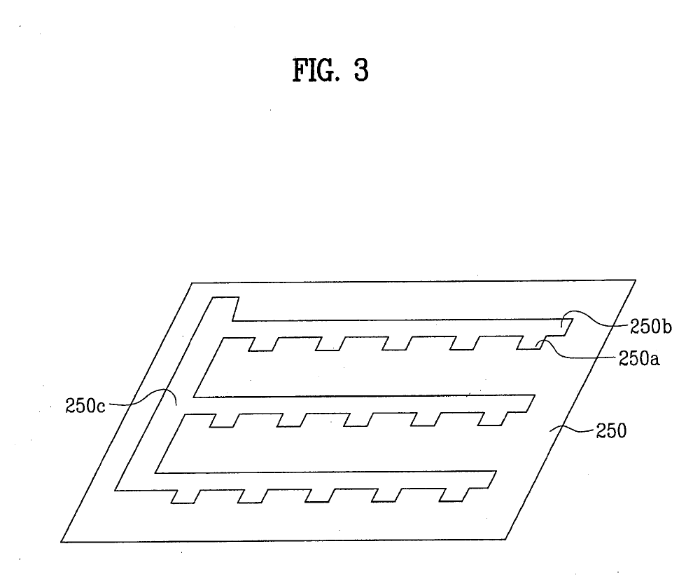

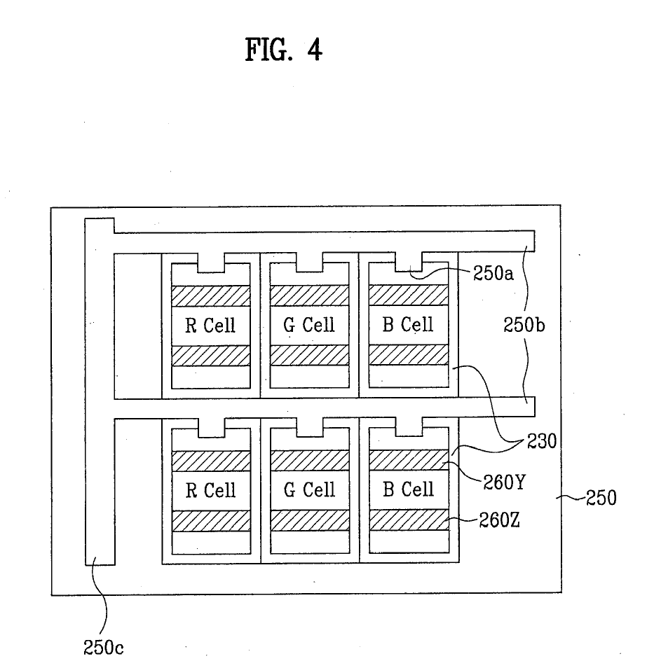

FIG. 3 is a view illustrating schematically the top substrate formed with the grooves of the plasma display panel in accordance with a first embodiment of the present invention, and FIG. 4 is a view illustrating mimetically the structure of discharge cells of the plasma display panel formed with the grooves in accordance with the first embodiment of the present invention. Hereinafter, the plasma display panel according to the first embodiment of the present invention will be described with reference to FIGS. 3 and 4.

A top substrate 250 of the plasma display panel is formed with one or more grooves 250a. The grooves 250a are connected to each other through first channels 250b, and the first channels 250b are connected to each other through a second channel 250c. The grooves 250a may not be formed on the top substrate 250 but formed on the upper dielectric substance in such a manner that the top substrate 250 is fabricated flat without the grooves and a portion of the upper dielectric substance is depressed to form the grooves 250a.

The grooves 250a may be formed to a depth of 20 to 1500 μm (50 μm for an XGA grade). Also, the grooves 250a may be formed at a width of 70 to 1000 μm (less than 700 μm, preferably 200 to 400 μm, for an XGA grade). The above width and depth of the grooves can be identically applied to the width and depth of the channels.

The first channels 250b and the second channel 250c may be formed on the upper dielectric substance. Preferably, the first channels 250b and the second channel 250c are formed on the top substrate 250. Also, the first channels 250b and the second channel 250c may be formed such that the surface of the top substrate 250 or the upper dielectric substance opposing the discharge spaces is depressed in a line type.

In this embodiment, if the barrier ribs are shaped in a well type (not a stripe type) and form independent discharge cells for each red, green and blue, the grooves 250a may be formed independently corresponding to the respective discharge cells. The grooves 250a may be formed as a hexahedral, semispherical, trapezoidal, or parabolic shape. The impurities inside the discharge spaces are stored temporarily in the first channels 250b and the second channel 250c, and exhausted outside of the plasma display panel through the first channels 250b and the second channel 250c.

The grooves 250a communicate with the exhaust port (not shown) through the first channels 250b and the second channel 250c. The exhaust port is formed on the upper panel, and may be provided by one or more. The barrier ribs 230 depicted in FIG. 4 have a well-type structure, and scan electrodes 260Y and sustain electrodes 260Z are formed on the top glass substrate correspondingly to the respective red, green and blue discharge cells.

When the grooves 250a, the first channels 250b, and the second channel 250c are formed on the top substrate 250, the scan electrodes 260Y, the sustain electrodes 260Z, the upper dielectric substance, and the protective film are formed on the top substrate 250 in order. Because the upper dielectric substance and the protective film are very thin when compared to the grooves 250a, the first channels 250b and the second channel 250c, the grooves and the channels can be formed in substantially the same shape on the top substrate contacting the discharge spaces even after the formation of the upper dielectric substance and the protective film. On the other hand, when the grooves 250a, the first channels 250b and the second channel 250c are formed on the upper dielectric substance, the top substrate 250 is formed at a uniform thickness and then the upper dielectric substance is fabricated at uneven heights so as to form the grooves 250a, the first channels 250b, and the second channel 250c.

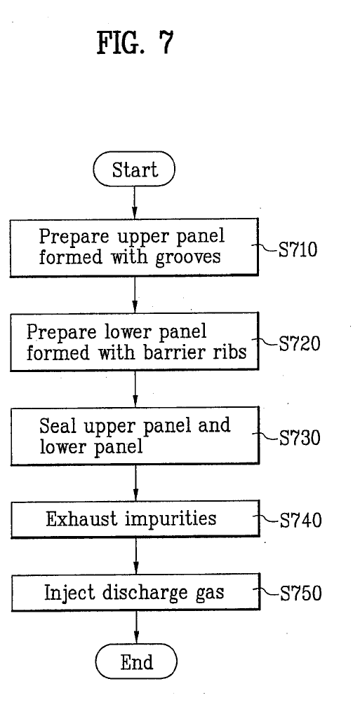

FIG. 7 is a flow chart illustrating a manufacturing method of the plasma display panel formed with the grooves in accordance with the present invention. Referring to FIG. 7, the manufacturing method of the plasma display panel according to the first embodiment of the present invention will now be described.

The upper panel formed with the grooves are fabricated (S710), and the lower panel formed with the barrier ribs are fabricated (S720). The upper panel is formed such that the grooves and the first and second channels are formed on the top substrate opposing the discharge regions. The grooves are connected to each other through the first and second channels. When the upper panel and the lower panel formed with the well-type barrier ribs are sealed, it is preferable to divide the grooves respectively and form the respective grooves on the top glass correspondingly to the respective discharge cells. It is preferable to form the grooves and the first and second channels by putting the top glass into a mold before plastic working. In particular, it is preferred that the grooves are formed as a hexahedral, semispherical, trapezoidal, or parabolic shape.

Thereafter, the scan electrodes, the sustain electrodes, the upper dielectric substance and the protective film are formed in order on the top substrate formed with the grooves and the first and second channels, thereby completing the fabrication of the upper panel of the plasma display panel. It is preferable to form the scan electrodes and the sustain electrodes using an off-set method or a printing method. Further, the upper dielectric substance and the protective film may be formed using a sputtering method or an electron beam deposition method. Accordingly, the shapes of the grooves and the first and second channels formed on the top substrate can be kept substantially identical.

Subsequently, the lower panel formed with the barrier ribs and the upper panel fabricated as above are sealed (S730). Preferably, a seal frit is used as a sealing material. The seal frit is applied with plastic and heating workings. Thereafter, the impurities are exhausted through the grooves and the channels (S740). Finally, in order to increase an efficiency of the plasma discharge, an inert gas containing helium (He), neon (Ne), or xenon (Xe) is injected into the discharge cells of the plasma display panel (S750).

Remaining processes except for the aforesaid processes are identical to a typical manufacturing method of the plasma display panel.

An operational effect of the plasma display panel according to the first embodiment of the present invention and the manufacturing method thereof will now be described.

When the sealing process of the upper panel and the lower panel is terminated, the impurities inside the discharge spaces are exhausted through the grooves and the first and second channels, and then the discharge gas can be injected into the discharge cells. The grooves and the first and second channels may be formed on the upper dielectric substance (not on the top substrate). In this case, the sustain electrode pairs are formed on the flat top substrate, and a partial layer of the upper dielectric substance layer is formed using an electron beam deposition method or a sputtering method. And, after a taping working, the remaining layer of the upper dielectric substance layer is deposited so as to form the shapes of the grooves and the first and second channels. Thereafter, the protective film of MgO is coated on the upper dielectric substance layer formed with the grooves and the first and second channels.

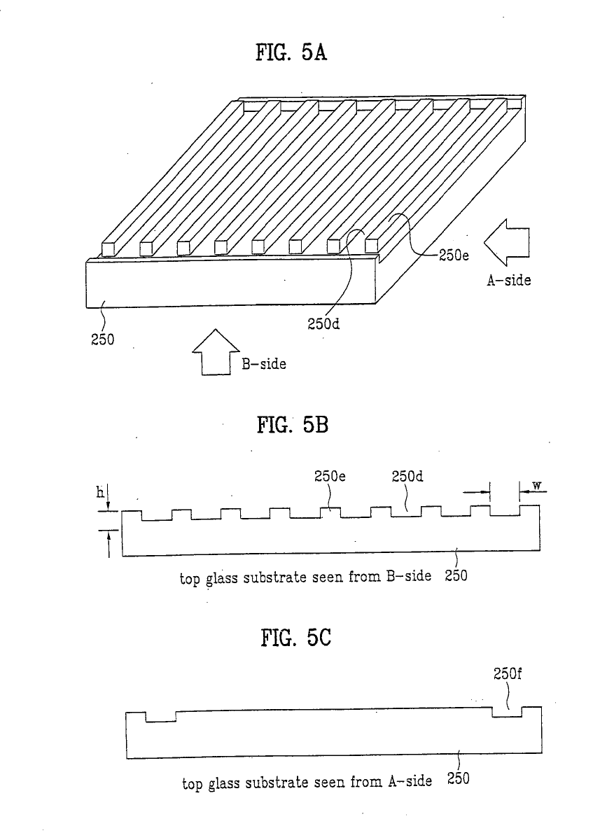

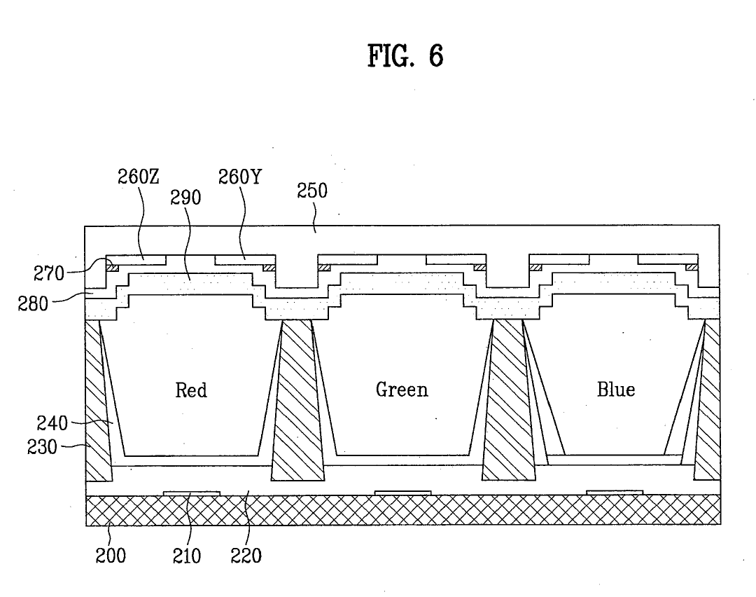

FIG. 5a is a perspective view illustrating schematically a top substrate formed with grooves of a plasma display panel in accordance with a second embodiment of the present invention, FIGS. 5b and 5c are sectional views seen from the B-side and the A-side in FIG. 5a, respectively, and FIG. 6 is a sectional view illustrating schematically the plasma display panel formed with the grooves in accordance with the second embodiment of the present invention.

This embodiment has a structural feature that grooves 250d are formed on the upper panel 250 in a line type. It is preferred that the grooves 250d are disposed in parallel with the stripe-type barrier ribs formed on the lower panel. The grooves 250d may be formed to a depth of 20 to 1500 μm (50 μm for an XGA grade). Also, the grooves 250d may be formed at a width of 70 to 1000 μm (less than 700 μm, preferably 200 to 400 μm, for an XGA grade).

The grooves 250d may be connected to channels 250f at both ends, so as to exhaust the impurity gas inside the discharge regions. The width and the depth of the channels 250f are equal to the width and the depth of the grooves 250d. The depth h refers to a height difference between a surface 250e where the grooves 250d are not formed and the grooves 250d, and the width w refers to the shortest distance from one of the grooves 250d to the other one of the grooves 250d.

After the grooves 250d and the channels 250f are formed on the top substrate 250, the scan electrodes 260Y, the sustain electrodes 260z, the upper dielectric substance 280, and the protective film 290 are formed on the top substrate 250 in order. Accordingly, the grooves 250d and the channels 250f are formed in substantially the same shape on the upper panel contacting the discharge spaces. The grooves 250d are formed on the upper panel opposing the discharge spaces, so as to have a function of forming a passage for exhausting the impurities above the discharge spaces. In this embodiment, if the barrier ribs are formed as a well type, it is preferable to form the grooves 250d on the upper panel correspondingly to the horizontal ribs. Also, the grooves and/or the channels may not be formed on the top substrate 250 but formed on the upper dielectric substance 280 in such a manner that the upper dielectric substance 280 is fabricated at uneven heights.

FIG. 7 is the flow chart illustrating the manufacturing method of the plasma display panel formed with the grooves in accordance with the present invention. Referring to FIG. 7, the manufacturing method of the plasma display panel according to the second embodiment of the present invention will now be described.

First, the upper panel formed with the grooves are fabricated (S710), and the lower panel formed with the barrier ribs are fabricated (S720). The upper panel is fabricated such that the grooves and the channels are formed on the top substrate opposing the discharge regions. The grooves are connected to the channels. When the upper panel and the lower panel formed with the stripe-type barrier ribs are sealed, it is preferable to form the grooves parallel with the respective discharge regions. When the upper panel and the lower panel formed with the well-type barrier ribs are sealed, it is preferable to form the grooves parallel with the horizontal ribs. Also, the grooves are connected to the channels at both ends, so that the impurities inside the discharge regions can be exhausted through the exhaust port via the channels.

Thereafter, the scan electrodes, the sustain electrodes, the upper dielectric substance and the protective film are formed in order on the top glass formed with the grooves and the channels, thereby completing the fabrication of the upper panel of the plasma display panel. It is preferable to form the scan electrodes and the sustain electrodes using an off-set method or a printing method. And, it is preferable to form the upper dielectric substance and the protective film using a sputtering method or an electron beam deposition method. Accordingly, the shapes of the grooves and the channels formed on the top substrate can be kept substantially identical. The grooves and the channels may be formed on the upper dielectric substance (not on the top substrate). In this case, the sustain electrode pairs are formed on the flat top substrate, and a partial layer of the upper dielectric substance layer is formed using an electron beam deposition method or a sputtering method. And, after a taping working, the remaining layer of the upper dielectric substance layer is deposited so as to form the shapes of the grooves and the channels. Thereafter, the protective film of MgO is coated on the upper dielectric substance layer formed with the grooves and the channels.

Subsequently, the lower panel formed with the barrier ribs and the upper panel fabricated as above are sealed (S730). Preferably, a seal frit is used as a sealing material. The seal frit is applied with plastic and heating workings. Thereafter, the impurities are exhausted through the grooves and the channels (S740). Finally, in order to increase an efficiency of the plasma discharge, An inert gas containing helium (He), neon (Ne), or xenon (Xe) is injected into the discharge cells of the plasma display panel (S750).

Remaining processes except for the aforesaid processes are identical to a typical manufacturing method of the plasma display panel.

An operational effect of the plasma display panel according to the second embodiment of the present invention and the manufacturing method thereof will now be described.

When the sealing process of the upper panel and the lower panel is terminated, the impurities inside the discharge spaces are exhausted through the exhaust port via the grooves and the channels, and then the discharge gas can be injected into the discharge cells.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A plasma display panel comprising:
discharge cells which are partitioned by an upper panel, a lower panel, and barrier ribs; and
at least one groove which is formed on the upper panel correspondingly to the discharge cells.

2. The plasma display panel according to claim 1, wherein the groove has a depth of 20 to 1500 μm.

3. The plasma display panel according to claim 1, wherein the groove has a width of 70 to 1000 μm.

4. The plasma display panel according to claim 1, wherein the groove is formed independently corresponding to each of the discharge cells.

5. The plasma display panel according to claim 1, wherein the groove has one of hexahedral, semispherical, trapezoidal, and parabolic shapes.

6. The plasma display panel according to claim 1, wherein the groove is formed on either a substrate of the upper panel or a dielectric substance of the upper panel.

7. The plasma display panel according to claim 1, further comprising:
channels which are formed on the upper panel correspondingly to the barrier ribs and connected to the groove.

8. The plasma display panel according to claim 7, wherein the channels include a first channel which is connected to the groove, and a second channel which is connected to the first channel and an exhaust port.

9. The plasma display panel according to claim 1, wherein the barrier ribs are formed as a stripe type, and the groove is formed as a line type and parallel with the barrier ribs.

10. The plasma display panel according to claim 9, further comprising:
a channel which is formed at an end of the groove formed as a line type.

11. The plasma display panel according to claim 9, wherein the groove has a depth of 20 to 1500 μm.

12. The plasma display panel according to claim 9, wherein the groove has a width of 70 to 1000 μm.

13. A method for manufacturing a plasma display panel, comprising:
forming at least one groove on an upper panel;
sealing the upper panel with a lower panel formed with barrier ribs; and
exhausting a gas inside discharge cells partitioned by the upper panel, the barrier ribs and the lower panel through the groove.

14. The method according to claim 13, further comprising:
forming channels connected to the groove on the upper panel.

15. The method according to claim 14, wherein the channels include a first channel which is connected to the groove, and a second channel which is connected to the first channel and an exhaust port.

16. The method according to claim 13, wherein the groove has one of hexahedral, semispherical, trapezoidal, and parabolic shapes.

17. The method according to claim 13, wherein the groove is formed on either a substrate of the upper panel or a dielectric substance of the upper panel.

18. The method according to claim 13, wherein the barrier ribs are formed as a stripe type, and the groove is formed as a line type and parallel with the barrier ribs.

19. The method according to claim 17, further comprising:
forming a channel at an end of the groove formed as a line type.

20. The method according to claim 13, further comprising:
injecting a discharge gas into the discharge cells.
